(19) United States
(12) Patent Application Publication
(10) Pub. No.: US 2020/0131005 A1
(43) Pub. Date: Apr. 30, 2020

(54) ELEVATOR SYSTEM

(71) Applicant: Otis Elevator Company, Farmington, CT (US)

(72) Inventor: Ergün Alkan, Berlin (DE)

(21) Appl. No.: 16/663,687

(22) Filed: Oct. 25, 2019

(30) Foreign Application Priority Data
Oct. 26, 2018 (EP) 18202947.0

(51) Int. Cl. B66B 13/22; B66B 5/00; B66B 5/02; B66B 13/02; B66B 13/24

(52) U.S. Cl. CPC B66B 13/22; B66B 5/0031; B66B 13/24; B66B 5/02; B66B 13/02; B66B 5/0025

(57) ABSTRACT

An elevator system (2) comprises at least one elevator car (6) configured for traveling along a hoistway (4) between a plurality of landings (8); a plurality of landing doors (11) with one or more landing door panels (22) located at the landings (8) and providing access to the hoistway (4) from the landings (8); a plurality of landing door switches (10) and at least one landing door sensor (20). Each landing door switch (10) is configured for monitoring the closed/open state of at least one associated landing door panel (22), respectively. Each landing door sensor (20) is attached to the at least one elevator car (6) and configured for monitoring a closed/open state of a landing door panel (22) located opposite to the landing door sensor (20).

### FOREIGN PRIORITY

This application claims priority to European Patent Application No. 18202947.0, filed Oct. 26, 2018, and all the benefits accruing therefrom under 35 U.S.C. § 119, the contents of which in its entirety are herein incorporated by reference.

### BACKGROUND

The invention relates to an elevator system, in particular to an elevator system with improved hoistway access detection. The invention further is related to a method of detecting an unauthorized entry to the hoistway of an elevator system.

An elevator system typically comprises at least one elevator car moving along a hoistway between a plurality of landings, and a driving member, which is configured for driving the elevator car. In order to allow passengers to transfer between the elevator car and the landings, landing doors are provided at the landings.

For detecting access to the hoistway, landing door switches monitoring whether a landing door associated with the respective switch is open or closed are provided at the landing doors. The landing door switches may be serially connected with each other forming a safety chain indicating whether at least one of the landing doors has been opened.

Additionally, the landing doors may be provided with landing door locks configured for locking the landing doors and monitored by additional landing door lock switches. The landing door lock switches may be serially connected with each other forming an additional safety chain indicating whether at least one of the landing doors is unlocked.

During normal operation, the landing door at the landing where the elevator car is positioned is closed and unlocked in order to allow passengers to open the landing door and to enter the elevator car, whereas the landing doors at other landings are regularly closed and locked in order to prevent access to the hoistway.

A closed and unlocked landing door may be opened regularly during normal operation for accessing or exiting the elevator car, when an elevator car is positioned at the respective landing, or a locked and closed landing door may be unlocked and opened irregularly for accessing the hoistway, when no elevator car is positioned at the respective landing, e.g. during maintenance, or in case a person tries to access the hoistway for an abusive purpose like climbing in the hoistway or riding on top of the elevator car. For safety, it is important to stop the movement of the elevator car, or at least operate the elevator system in a restricted mode of operation, in case of an irregular opening of a landing door.

A regular opening of a landing door refers to the case where a closed landing door already unlocked by the elevator control to allow regular service is opened by a user wishing to enter or exit the elevator car. An irregular opening of a landing door refers to the case where a closed and locked door is first unlocked and then opened by a person wishing to enter the hoistway above or below the elevator car.

It would be beneficial to provide such an elevator system allowing for improved hoistway access detection, which in particular allows determining whether a landing door has been opened regularly or irregularly when the elevator car is stationary at a landing.

### BRIEF DESCRIPTION

According to an exemplary embodiment of the invention, an elevator system comprises at least one elevator car configured for traveling along a hoistway between a plurality of landings and a plurality of landing doors located at the landings and providing access to the hoistway from the landings. Exemplary embodiments of the invention may include elevator systems comprising single panel landing doors and elevator systems comprising multi panel landing doors.

The elevator system further comprises a plurality of landing door switches (stationary landing door sensors); additionally, it comprises one or more landing door sensors (mobile landing door sensors) attached to at least one elevator car. The elevator system may further comprise a plurality of landing door lock switches Each of the landing door switches is configured for monitoring the closed/open state of a respectively associated landing door; If present, each of the landing door lock switches is configured for monitoring the locked/unlocked state of a respectively associated landing door; Each of the landing door sensors is configured for monitoring the closed/open state of a landing door panel located opposite to the landing door sensor. In other words, when the elevator car is positioned at one of the landings, each landing door sensor is configured for monitoring the closed/open state of the opposite panel of the landing door of the landing at which the elevator car is currently positioned.

A landing door is considered to be open when any one of its panels is open or not completely closed, and is considered closed when all its panels are arranged in a completely closed position.

Exemplary embodiments of the invention further include a method of monitoring an elevator system comprising at least one elevator car configured for traveling along a hoistway between a plurality of landings; and a plurality of landing doors located at the landings and providing access to the hoistway from the landings. The method includes detecting, in particular when the elevator car is positioned at a landing, whether all landing doors are in a defined state, and in case not all landing doors are in the defined state, detecting whether a landing door located at the current position of the elevator car is in the defined state or not.

Monitoring the state of the landing door may include detecting whether the landing door is open, i.e. not completely closed, or closed.

In case at least one of the landing door switches indicates that at least one of the landing doors is not completely closed and at least one of the landing door sensors indicates that the landing door opposite to an entrance of the elevator car is open, or at least not completely closed, it is determined that the landing door at the landing at which the elevator car is currently positioned, has been regularly opened in order to allow passengers to transfer between the elevator car and the respective landing.

In case, however, at least one of the landing door switches indicates that at least one of the landing doors is open and all the landing door sensors indicate that the landing door opposite to the elevator car door is closed, it is determined that a “wrong” landing door, i.e. a landing door at a landing at which the elevator car is currently not positioned, has been irregularly opened providing access to an area of the hoistway above or below the elevator car.

As long as the landing door opposite to an entrance of the elevator car is open, or at least not completely closed, it is not possible to detect whether another landing door at another landing has been opened irregularly or not. In such a case, the detection becomes possible as soon as the open landing door opposite to the entrance of the elevator car is completely closed.

Thus, an elevator system according to an exemplary embodiment of the invention allows reliably distinguishing between a state in which a landing door is regularly opened and a state in which at least one of the landing doors is irregularly opened when the elevator car is stationary at a landing. In consequence, the safety of the elevator system may be enhanced considerably.

A number of optional features are set out in the following. Unless explicitly mentioned otherwise, any of these features may be realized in particular embodiments, alone or in combination with any of the other features.

The elevator system may comprise an elevator control configured for determining a safety state of the elevator system based on the states of the landing doors detected by the landing door switches, the landing door lock switches, if present, and the landing door sensors. As a result, the elevator control may control the elevator system according to the determined safety state of the elevator system.

The elevator control in particular may be configured for determining that the elevator system is in a safe state when all landing door switches indicate that the associated landing doors are closed or when at least one landing door switch indicates that the associated landing door is open (not completely closed) and at least one of the landing door sensors indicates that the landing door located opposite to the elevator is open (not completely closed). The elevator system may be operated normally as long as the elevator system is determined to be in a safe state.

The elevator control further may be configured for determining that the elevator system is in an unsafe state when at least one of the landing door switches indicates that the associated landing door is open (not completely closed) and all the landing door sensors indicate that the landing door located opposite to the elevator car is closed, as this indicates that at least one landing door, which is not located opposite to the current position of the elevator car, has been unlocked and opened.

The elevator control may be configured for stopping any further operation of the elevator system as soon as the elevator system has been detected as being in an unsafe state in order to prevent persons entering the hoistway from being hit or squeezed by the elevator car.

The elevator control may be configured for switching into a maintenance state of operation as soon as the elevator system has been detected as being in an unsafe state, in order to enhance the safety of persons entering the hoistway. Operating the elevator system in a maintenance mode may include reducing the maximum speed of the elevator car and/or restricting the moving range of the elevator car in order to prevent persons within the hoistway from being hit and/or squeezed by the elevator car.

The landing doors of the elevator system may comprise at least the following two chains of switches: The landing door switches may be serially connected with each other forming a safety chain which is interrupted when at least one of the landing door switches is opened. This safety chain may be configured for detecting whether all the landing doors in the elevator hoistway are closed or whether at least one of the landing doors in the elevator hoistway is opened. Such a safety chain allows for a safe operation of the elevator system as the opening of at least one of the landing door switches is reliably detected; the landing door lock switches may be serially connected with each other forming an additional safety chain which is interrupted when at least one of the landing door lock switches is opened. This additional safety chain is configured for detecting whether all the landing doors in the elevator hoistway are locked or whether at least one of the landing doors in the elevator hoistway is unlocked.

The elevator control may be configured for monitoring the safety chains separately or in combination.

The landing door sensor may be a proximity sensor configured for detecting the presence of a landing door panel in a defined detection zone in the proximity of the landing door sensor for determining whether a landing door located opposite to the landing door sensor is open or closed, i.e. whether all landing door panels of the landing door are arranged in a closed position or at least one of the landing door panels is arranged in an open position.

The landing door sensor may be at least one of an inductive sensor, a capacitive sensor, an optical sensor, an ultrasonic sensor and a mechanical sensor, or any combination thereof.

The landing doors may be manually operated landing doors, which may be provided at low costs. They may comprise one or more panels with or without hinge.

Alternatively, the landing doors may be motor driven landing doors providing more comfort to the passengers than manually operated landing doors.

The landing doors may include sliding doors respectively comprising at least one sliding landing door panel.

The sliding doors may be telescopic doors comprising at least two landing door panels moving concordantly with each other in the same direction. Alternatively, the sliding doors may be symmetric doors comprising at least two landing door panels moving in opposite directions when the doors are opening and/or closing.

In case the landing doors comprise a plurality of landing door panels, each landing door panel or a group of landing door panels may be provided with a landing door switch. In this case, for each column of panels arranged along the height of the hoistway, a corresponding landing door sensor may be provided at the elevator car. Additionally, in case the landing doors are provided with locks, each landing door panel or a group of landing door panels may be provided with a landing door lock switch.

### DRAWING DESCRIPTION

In the following, an exemplary embodiment of the invention is described in more detail with respect to the enclosed figures.

FIG. 1 schematically depicts an elevator system according to an exemplary embodiment of the invention.

FIG. 2 schematically depicts a landing door of an elevator system according to an exemplary embodiment of the invention.

### DETAILED DESCRIPTION

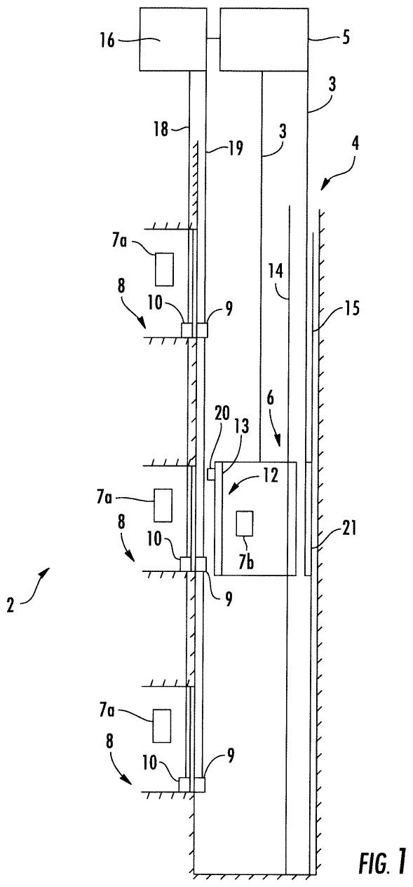

FIG. 1 schematically depicts an elevator system 2 according to an exemplary embodiment of the invention.

The elevator system 2 includes an elevator car 6 which is movably arranged within a hoistway 4 extending between a plurality of landings 8. The elevator car 6 in particular is movable along a plurality of car guide members 14, such as guide rails, extending along the vertical direction of the hoistway 4. Only one of said car guide members 14 is visible in FIG. 1. Although only one elevator car 6 is depicted in FIG. 1, the skilled person will understand that exemplary embodiments of the invention may include elevator systems 2 having a plurality of elevator cars 6 moving in one or more hoistways 4.

The elevator car 6 is movably suspended by means of a tension member 3. The tension member 3, for example a rope or belt, is connected to a drive unit 5, which is configured for driving the tension member 3 in order to move the elevator car 6 along the height of the hoistway 4 between the plurality of landings 8, which are located on different floors.

Each landing 8 is provided with a landing door 11, and the elevator car 6 is provided with a corresponding elevator car entrance 12 for allowing passengers to transfer between a landing 8 and the interior of the elevator car 6 when the elevator car 6 is positioned at the respective landing 8. Elevator car entrance 12 may not be provided with any doors. Optionally, a motor driven or manually operated elevator car door 13 may be provided at the elevator car entrance 12.

The landing doors 11 may be motor driven landing doors 11 or manually operated landing doors 11, which are configured for being opened manually by the passengers.

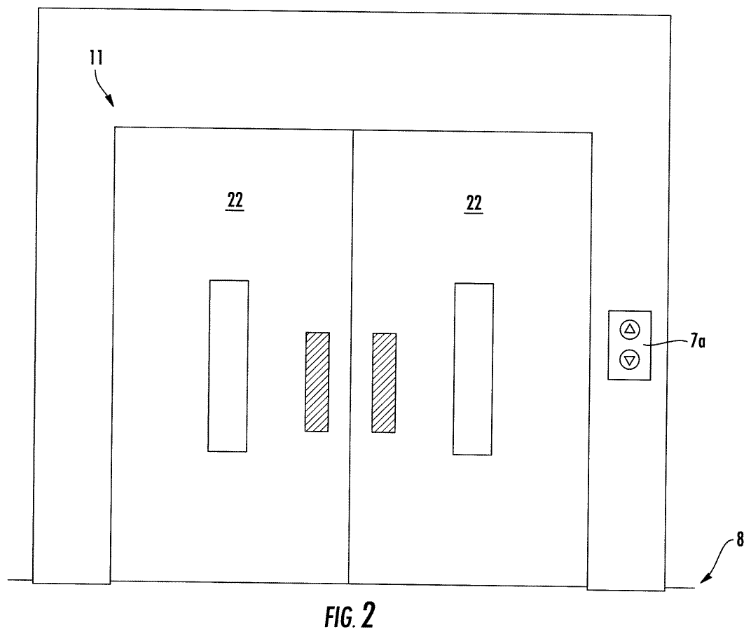

The landing doors 11 may comprise one or more hinged and pivotable landing door panels 22. FIG. 2 depicts landing doors 11 comprising two pivotable landing door panels 22 with hinge.

In another configuration, the landing doors 11 may be manually operated landing doors 11 comprising one or more landing door panels 22 without hinge.

The exemplary embodiment of an elevator system 2 depicted in FIG. 1 uses a 1:1 roping for suspending the elevator car 6. The skilled person, however, easily understands that the type of the roping is not essential for the invention and that different kinds of roping, e.g. a 2:1 roping or a 4:1 roping may be used as well.

The elevator system 2 includes further a counterweight 21 attached to the tension member 3 opposite to the elevator car 6 and moving concurrently and in opposite direction with respect to the elevator car 6 along at least one counterweight guide member 15. The skilled person will understand that the invention may be applied to elevator systems 2 which do not comprise a counterweight 21 as well.

The tension member 3 may be a rope, e.g. a steel core, or a belt. The tension member 3 may be uncoated or may have a coating, e.g. in the form of a polymer jacket. In a particular embodiment, the tension member 3 may be a belt comprising a plurality of polymer coated steel cords (not shown). The elevator system 2 may have a traction drive including a traction sheave for driving the tension member 3. In an alternative configuration, which is not shown in the figures, the elevator system 2 may be an elevator system 2 without a tension member 3, comprising e.g. a hydraulic drive or a linear drive. The elevator system 2 may have a machine room (not shown) or may be a machine room-less elevator system.

The drive unit 5 is controlled by an elevator control 16 configured for moving the elevator car 6 along the hoistway 4 between the different landings 8.

Input to the elevator control 16 may be provided via landing control panels 7a, which are provided on each landing 8 close to the landing doors 11, and/or via an elevator car control panel 7b, which is provided inside the elevator car 6.

The landing control panels 7a and the elevator car control panel 7b may be connected to the elevator control 16 by means of electrical wiring, which is not shown in FIG. 1, in particular by an electric bus, or by means of wireless data connections.

At least one stationary landing door switch 10 is provided at each of the landing doors 11. Each of the landing door switches 10 is configured for detecting whether the respectively associated landing door 11 is open or completely closed. Each of the landing door switches 10 in particular may be configured to be open in case at least one landing door panel 22 of the respectively associated landing door 11 is not completely closed, and all the landing door switches 10 may be configured to be closed in case all landing door panels 22 of the respectively associated landing door 11 are completely closed.

A landing door 11 is considered open when any one of its landing door panels 22 is open or not completely closed and is considered closed when all its landing door panels 22 are completely closed.

The landing door switches 10 may be serially connected with each other forming parts of an electric safety chain 18 connected with the elevator control 16.

The safety chain 18 is completely closed signaling that the elevator system 2 is in a safe state in case all landing door switches 10 are closed. The safety chain 18 is open signaling that at least one of the landing door switches 10 is open indicating that the landing door 11 associated with the at least one open landing door switch 10 is not completely closed.

At least one stationary landing door lock switch 9 may be provided at each of the landing doors 11. If present, each of the stationary landing door lock switches 9 is configured for detecting whether the respectively associated landing door 11 is locked or unlocked. Each of the stationary landing door lock switches 9 in particular may be configured to be open in case at least one landing door panel 22 of the respectively associated landing door 11 is not locked, and all the landing door lock switches 9 may be configured to be closed in case all the landing panels 22 of the respectively associated landing door 11 are locked.

The landing door lock switches 9 may be serially connected with each other forming components of an additional electric safety chain 19 connected with the elevator control 16. This additional safety chain 19 may be closed signaling that all landing doors 11 are locked; or it may be open signaling that at least one of the landing doors 11 is unlocked.

For simplicity and clarity of the description, in the following an elevator system 2 is described which is configured for detecting whether the landing doors 11 are open or (completely) closed. The elevator system 2 additionally may be configured for detecting whether the landing doors 11 are locked or unlocked, as it has been described before.

After the elevator car 6 has been stopped at one of the landings 8, the landing door 11 at said landing 8 is unlocked and may be opened for allowing passengers to transfer between the elevator car 6 and the respective landing 8.

Thus opening the landing door 11 located at the landing 8 at which the elevator car 6 has stopped is part of the normal operation of the elevator system 2.

Opening another landing door 11, i.e. a landing door 11 at a landing 8 at which the elevator car 6 is currently not positioned, however, allows a person to enter the hoistway 4 via said open landing door 11 resulting in an unsafe state of the elevator system 2. Thus, it is desirable that the elevator control 16 stops any further operation of the elevator system 2 or switches the elevator system 2 into a maintenance mode, in case the landing door 11 of a landing 8 at which the elevator car 6 is currently not positioned is opened.

The safety chain 18, however, allows only detecting whether all landing doors 11 are closed or whether at least one landing door 11 is open, but it does not allow determining the position of an open landing door 11.

Thus, according to an exemplary embodiment of the invention, the elevator car 6 is equipped with landing door sensors 20 configured for detecting the state of the landing door panels 22 at the landing 8 at which the elevator car 6 is currently positioned.

Thus, in case the safety chain 18 is interrupted indicating that one of the landing doors 11 has been opened, and at least one of the landing door sensors 20 mounted to the elevator car 6 indicates that the landing door 11 located opposite to the elevator car entrance 12 is open, the elevator control 16 concludes that the correct landing door 11, i.e. the landing door 11 at the landing 8 at which the elevator car 6 is currently positioned, has been opened in order to allow passengers to transfer between the elevator car 6 and the respective landing 8.

In case, however, the safety chain 18 is interrupted indicating that one of the landing doors 11 has been opened, and all the landing door sensors 20 mounted to the elevator car 6 indicates that the landing door 11 located opposite to the elevator car entrance 12 is closed, the elevator control 16 concludes that a wrong landing door 11, i.e. a landing door 11 at a landing 8 at which the elevator car 6 is not currently positioned, has been opened providing access to a portion of the hoistway 4 above or below the elevator car 6.

In consequence, the elevator control 16 may issue an optical and/or acoustical alarm signal indicating a potentially dangerous situation.

Alternatively or additionally, the elevator control 16 may stop any further operation of the elevator system 2, in particular any further movement of the elevator car 6, in order to prevent a person which has entered the hoistway 4 via the open landing door 11 from being hit or squeezed by a moving elevator car 6. Alternatively to stopping any further operation of the elevator system 2, the elevator control 16 may switch the elevator system into a maintenance mode allowing only a restricted movement of the elevator car 6, e.g. moving the elevator car 6 with reduced speed and/or restricting the uppermost and lowermost positions in the hoistway 4 which may be reached by the elevator car 6.

Each landing door sensor 20 may be a proximity sensor configured for detecting the presence or absence of a landing door panel 22 in a defined detection zone next to the landing door sensor 20.

The presence of all the landing door panels 22 within the detection zone indicates that the respective landing door 11 is closed, whereas the absence of at least one of the landing door panels 22 within the detection zone indicates that the respective landing door 11 is open or at least not completely closed.

Each landing door sensor 20 may be an inductive sensor configured for detecting the presence of metal or a magnet within the detection zone. At least one landing door panel 22 of each landing door 11 may be made of metal, or a piece of metal or a magnet may be attached to at least one landing door panel 22 of each landing door 11 for being detected by the landing door sensor 20 when arranged within the detection zone.

In another configuration, each landing door sensor 20 may be a capacitive sensor configured for detecting the presence of a non-metal door panel 22 or a metal door panel 22 with a non-metal finish within the detection zone. Additionally, a capacitive sensor may also be suitable to detect a metal door panel 22 as well.

In another configuration, each landing door sensor 20 may be an optical sensor configured for detecting light reflected by a landing door panel 22 or light which is not blocked in the absence of a landing door panel 22.

In another configuration, each landing door sensor 20 may be an ultrasonic sensor configured for detecting the sound reflected by a landing door panel 22.

In yet another configuration, each landing door sensor 20 may be a mechanical sensor configured for detecting the presence and/or absence of a landing door panel 22 based on a mechanical interaction between the landing door panel 22 and the landing door sensor 20.

Each landing door sensor 20 also may comprise a combination of at least two of an inductive sensor, a capacitive sensor, an optical sensor, an ultrasonic sensor and a mechanical sensor in order to enhance the reliability due to redundancy.

Although an elevator car 6 comprising only a single elevator car entrance 12 is depicted in FIG. 1, the skilled person understands that the application similarly may be applied to elevator systems 2 comprising elevator cars 6 with more than one elevator car entrances 12. The elevator car entrances 12 in particular may be formed in different sidewalls of the elevator car 12 allowing passengers to enter and leave the elevator car 12 from/in different directions.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 tension member
4 hoistway
5 drive unit
6 elevator car
7a landing control panel
7b elevator car control panel
8 landing
9 landing door lock switch
10 landing door switch
11 landing door
12 elevator car entrance
13 elevator car door
14 car guide member
15 counterweight guide member
16 elevator control
18 safety chain
19 additional safety chain
20 landing door sensor
21 counterweight
22 landing door panel

What is claimed is:

1. Elevator system (2) comprising:
at least one elevator car (6) comprising at least one elevator car entrance (12) and configured for traveling along a hoistway (4) between a plurality of landings (8);
a plurality of landing doors (11) located at the landings (8) and providing access to the hoistway (4) from the landings (8);
a plurality of landing door switches (10); and
at least one landing door sensor (20);
wherein each landing door switch (10) is configured for monitoring the open/closed state of an associated landing door (11), in particular of at least one associated landing door panel (22); and
wherein each landing door sensor (20) is attached to the at least one elevator car (6) and configured for monitoring the open/closed state of a landing door panel (22) currently located opposite to the landing door sensor (20).

2. Elevator system (2) according to claim 1, further comprising an elevator control (16) configured for determining a state of the elevator system (2) based on the states of the landing doors (11) detected by the landing door switches (10) and the at least one landing door sensor (20).

3. Elevator system (2) according to claim 2, wherein the elevator control (16) is configured for determining a safe state of the elevator system (2) if all landing door switches (10) indicate that the associated landing doors (11) are closed or if at least one of the landing door switches (10) indicates that the associated landing door (11) is open and at least one landing door sensor (20) indicates that the opposing landing door (11) is open.

4. Elevator system (2) according to claim 2, wherein the elevator control (16) is configured for determining an unsafe state of the elevator system (2) if at least one of the landing door switches (10) indicates that the associated landing door (11) is open and all landing door sensors (20) indicate that the opposing landing door (11) is closed.

5. Elevator system (2) according to claim 4, wherein the elevator control (16) is configured for stopping any further operation of the elevator system (2) as soon as an unsafe state of the elevator system (2) has been detected.

6. Elevator system (2) according to claim 4, wherein the elevator control (16) is configured for switching into a maintenance state of operation as soon as an unsafe state of the elevator system (2) has been detected.

7. Elevator system (2) according to claim 1, wherein at least some of the plurality of landing door switches (10) are serially connected with each other to form a safety chain (18) which is interrupted when at least one of the landing door switches (10) is open.

8. Elevator system (2) according to claim 1, comprising a plurality of landing door lock switches (9), wherein at least some of the plurality of landing door lock switches (9) are serially connected with each other to form an additional safety chain (19) which is interrupted when at least one of the landing door lock switches (9) is open.

9. Elevator system (2) according to claim 1, wherein each landing door sensor (20) is a proximity sensor configured for detecting the presence of a landing door panel (22) in the proximity of the respective landing door sensor (20).

10. Elevator system (2) according to claim 1, wherein each landing door sensor (20) is at least one of an inductive sensor, a capacitive sensor, an optical sensor, an ultrasonic sensor and a mechanical sensor.

11. Elevator system (2) according to claim 1, wherein the landing doors (11) are manually operated landing doors (11) comprising one or more landing door panels (22) with or without hinge.

12. Elevator system (2) according to claim 1, wherein the landing doors (11) include manually operated landing doors (11) and/or motor driven landing doors (11).

13. Elevator system (2) according to claim 1, wherein the at least one elevator car entrance (12) is provided with at least one elevator car door (13), in particular with at least one manually operated car door (13) or with at least one motor driven car door (13), or wherein the at least one elevator car entrance (12) is not provided with an elevator car door (13) at all.

14. Elevator system (2) according to claim 1, wherein the elevator car (6) is provided with at least two elevator car door entrances (12).

15. Method of monitoring an elevator system (2) comprising:
at least one elevator car (6) configured for traveling along a hoistway (4) between a plurality of landings (8); and
a plurality of landing doors (11) located at the landings (8) and providing access to the hoistway (4) from the landings (8);
wherein the method includes
detecting, when the elevator car (6) is positioned at a landing, whether all landing doors (11) are in a defined state, and
in case not all landing doors (11) are in the defined state, detecting whether a landing door (11) located at the current position of the elevator car (6) is in the defined state.
